(19) United States
(12) Patent Application Publication
(10) Pub. No.: US 2022/0027734 A1
(43) Pub. Date: Jan. 27, 2022

(54) REGION OF INTEREST CONVOLUTIONAL NEURAL NETWORK PROCESSING

(71) Applicant: AUTOBRAINS TECHNOLOGIES LTD, Tel Aviv (IL)

(72) Inventors: Yuval Woldman, Giv'atayim (IL); Roi Saida, Acco (IL)

(73) Assignee: AUTOBRAINS TECHNOLOGIES LTD, Tel Aviv (IL)

(21) Appl. No.: 17/443,251

(22) Filed: Jul. 22, 2021

Related U.S. Application Data
(60) Provisional application No. 62/705,923, filed on Jul. 22, 2020.

(51) Int. Cl. G06N 3/08; G06N 3/063

(52) U.S. Cl. CPC G06N 3/08; G06N 3/063

(57) ABSTRACT

An apparatus that may include a neural network processor, the neural network processor comprises multiple building blocks. Each of the at least some of the building blocks may include, may consist or may consist essentially of an input, an output and at least one array convolution unit.

### BACKGROUND

One of the most common neural networks is a convolutional neural network (CNN). CNN requires extensive computational resources and may consume a lot of energy.

There is a growing need to reduce the energy consumption of CNN calculations.

### SUMMARY

There may be provided a method, system and computer readable medium for CNN and CNN processing.

### BRIEF DESCRIPTION OF THE DRAWINGS

The embodiments of the disclosure will be understood and appreciated more fully from the following detailed description, taken in conjunction with the drawings in which:

FIG. 1 illustrates an example of a method;

FIG. 2 illustrates an example of a method;

FIG. 3 illustrates an example of a method;

FIG. 4 illustrates an example of a neural network; and

FIG. 5 illustrates an example of a neural network processor.

### DESCRIPTION OF EXAMPLE EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the present invention may for the most part, be implemented using electronic components and circuits known to those skilled in the art, details will not be explained in any greater extent than that considered necessary as illustrated above, for the understanding and appreciation of the underlying concepts of the present invention and in order not to obfuscate or distract from the teachings of the present invention.

Any reference in the specification to a method should be applied mutatis mutandis to a device or system capable of executing the method and/or to a non-transitory computer readable medium that stores instructions for executing the method.

Any reference in the specification to a system or device should be applied mutatis mutandis to a method that may be executed by the system, and/or may be applied mutatis mutandis to non-transitory computer readable medium that stores instructions executable by the system.

Any reference in the specification to a non-transitory computer readable medium should be applied mutatis mutandis to a device or system capable of executing instructions stored in the non-transitory computer readable medium and/or may be applied mutatis mutandis to a method for executing the instructions.

Any combination of any module or unit listed in any of the figures, any part of the specification and/or any claims may be provided.

The terms feature and channel are used in an intermediate manner. For example, an input image may include three channels—red, green and blue. Accordingly—the input image has three features.

A CNN has an input layer, multiple intermediate layers and an output layers. The CNN may be implemented by a CNN processor. The CNN processor may include a convolution unit that may be controlled by a controller.

It has been found that not all CNN calculations are necessary. For example—a user may be interested in performing calculations related to a region of interest within an intermediate layer—and in this case there may be no need to perform calculations relates to areas outside the region of interest.

Defining ROIs in one or more intermediate layers provides various improvements in computer science—for example is saves energy, the reduction in the number of calculations also speeds up the CNN processing, and the quality of the calculation may be improved—by preventing ‘ghosts’ or ‘mis-information’ or any other unwanted effects that calculations outside the ROI may introduce—or allow saved calculations cost to be added to the calculation allowance allocated to the ROI.

An intermediate layer may have multiple ROIs. Any reference to an ROI of an intermediate layer should be applied mutatis mutandis to multiple ROIs of the intermediate layer.

The ROI of the intermediate layer may be defined in various manners—for example by deducting the areas of an input data that correspond to the different parts of the intermediate layer, and the like. Yet for another example—the definition can be made regardless of the input layer.

The ROI may be fixed or may be changeable. A fixed ROI is determined during the configuration of the CNN and may not be changed afterwards. The ROI may be of any shape and size. The ROI may be defined by determining the input to be fed (for example determining the memory addresses to be read) by the NN processor.

A changeable ROI may be changed over time. An example of an ROI that is changeable may be an ROI that may be set by instructions that may be changed over time. For example—when using a hardware convolutional unit that may be dynamically fed with information—the ROI may be changed by controlling the inputs that are fed to the hardware convolution unit. The ROI may also be changed when the CNN nodes are implemented in software.

The CNN processing may be implemented by a neural network processor such as a CNN processor. The CNN processor may be an integrated circuit, may include more than a single integrated circuit, may be a part of an integrated circuit, may be a hardware accelerator, may be tailored to neural network processing, may be applied on a general purpose integrated circuit, may be applied on a graphic processor, and the like. The apparatus may be a computerized system, a part of a computerized system, may be a part of a laptop, desktop, a vehicle dedicated integrated circuit, and the like.

The CNN processor may be a Renesas Electronics integrated circuit for vehicles.

Such integrated circuit, for example the Renesas integrated circuit exhibit a very low power consumption and are very popular among vehicle vendors.

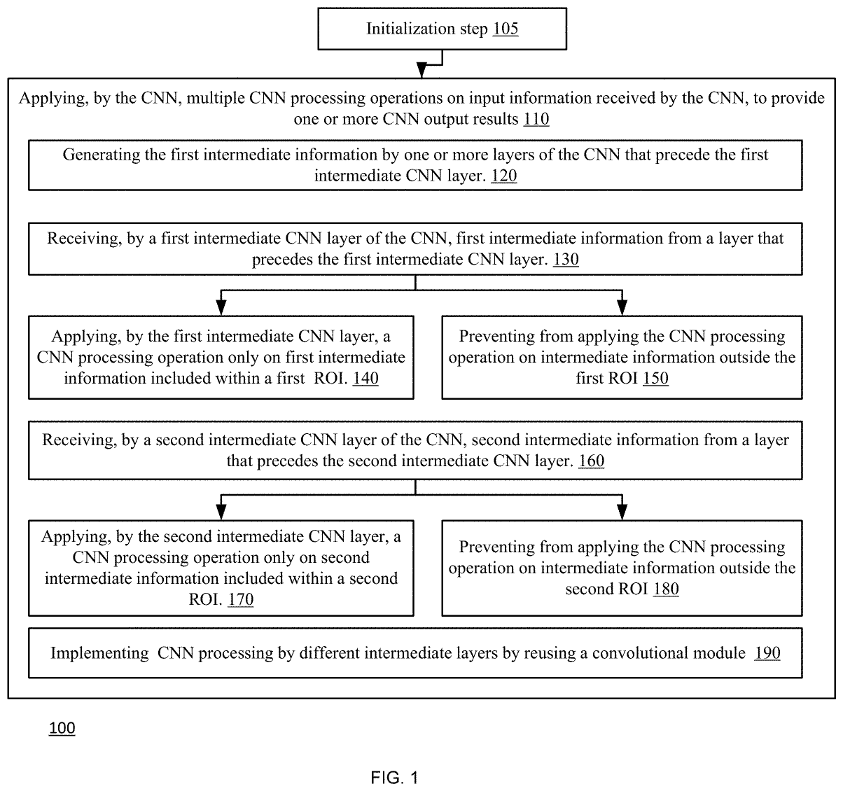

FIG. 1 illustrates method 100 for ROI CNN processing.

Method 100 may include initialization step 105. The initialization step may include defining (or receiving a definition of) one or more ROIs of a CNN.

Step 105 may be followed by step 110 of applying, by the CNN, multiple CNN processing operations on input information received by the CNN, to provide one or more CNN output results.

It should be noted that step 105 may be include din step 110.

Step 110 may include steps 130, 140 and 150.

Step 130 may include receiving, by a first intermediate CNN layer of the CNN, first intermediate information from a layer that precedes the first intermediate CNN layer.

Step 140 may include applying, by the first intermediate CNN layer, a CNN processing operation only on first intermediate information included within a first ROI.

Step 150 may include preventing from applying the CNN processing operation on intermediate information outside the first ROI.

Step 110 may include steps 160, 170 and 180.

Step 160 may include receiving, by a second intermediate CNN layer of the CNN, second intermediate information from a layer that precedes the second intermediate CNN layer; wherein the second intermediate CNN layer differs from the first intermediate CNN layer.

Step 170 may include applying, by the second intermediate CNN layer, a CNN processing operation only on second intermediate information included within a second region of interest (ROI).

Step 180 may include preventing from applying the CNN processing operation on intermediate information outside the second ROI.

Step 110 may include step 120 of generating the first intermediate information by one or more layers of the CNN that precede the first intermediate CNN layer.

Step 120 may include step 190 of implementing CNN processing by different intermediate layers by reusing a convolutional module. The reusing means that CN processing operations regarding different intermediate layers include feeding the convolution module in an iterative manner—for performing calculations related to different convolutional layers. One or more iterations may be allocated to a single intermediate layer.

Step 190 may include dynamically adjusting regions of interest between one use of the convolutional module to another. The dynamic adjustment may include determining which input to provide to the convolutional module—for example not providing inputs of an intermediate layer that does not belong to a ROI of that intermediate layer.

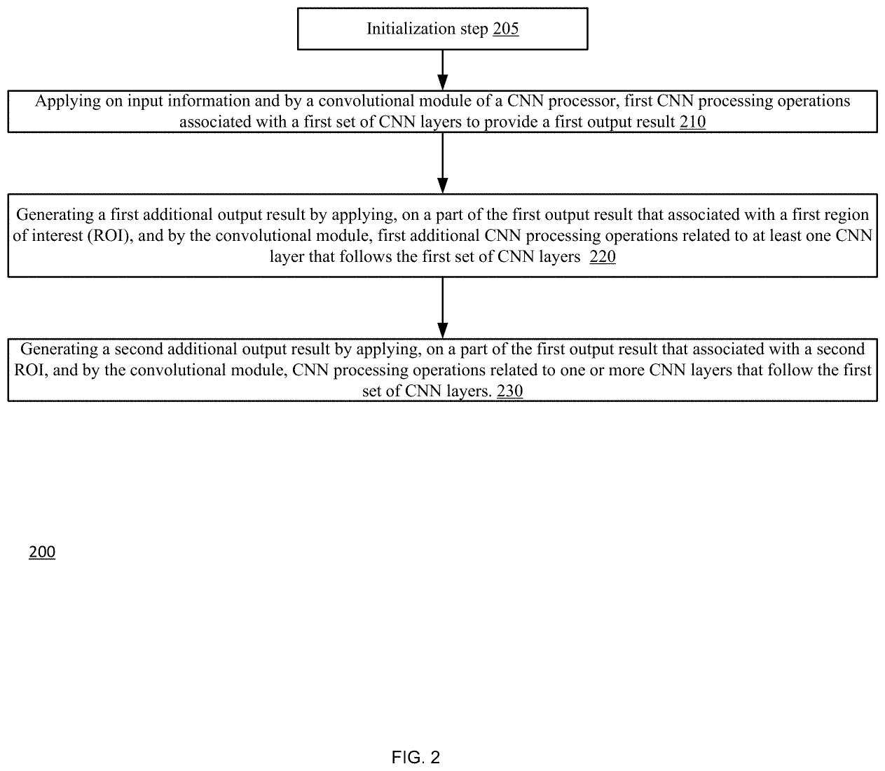

FIG. 2 illustrates method 200 for CNN processing.

Method 200 may include initialization step 205. The initialization step may include defining or receiving a definition of one or more ROIs of a CNN.

Step 205 may be followed by step 210 of applying on input information and by a convolutional module of a CNN processor, first CNN processing operations associated with a first set of CNN layers to provide a first output result.

The first output result may a preliminary result that does not amount to an outcome of a complete object detection process. For example—the first output results may provide an indication on image features such as edges, and the like—but does not amount to a detection of an object. An example of an preliminary result is illustrated in FIG. 1E (for example output of second layer of CNN) of PCT patent application publication serial number WO2020/079508 which is incorporated herein by reference.

Step 210 may be followed by step 220 of generating a first additional output result by applying, on a part of the first output result that associated with a first region of interest (ROI), and by the convolutional module, first additional CNN processing operations related to at least one CNN layer that follows the first set of CNN layers.

Step 220 may be followed by step 230 of generating a second additional output result by applying, on a part of the first output result that associated with a second ROI, and by the convolutional module, CNN processing operations related to one or more CNN layers that follow the first set of CNN layers.

The first ROI is associated with a detection of a first type of object and the second ROI is associated with a second type of object.

The applying of the first CNN processing may be associated with a detection of objects of the first and second types.

Either one of method 200 and 100 may be applied on all layers of a CNN— including an input layer, all intermediate layers and the output layer. For each intermediate layer the method may determine whether all the information inputted to the intermediate layer should be processed—or —when there is an ROI associated with the intermediate layer—processing only input data related to the ROI of that intermediate layer. It should be noted that the ROI may also be defined for the output layer.

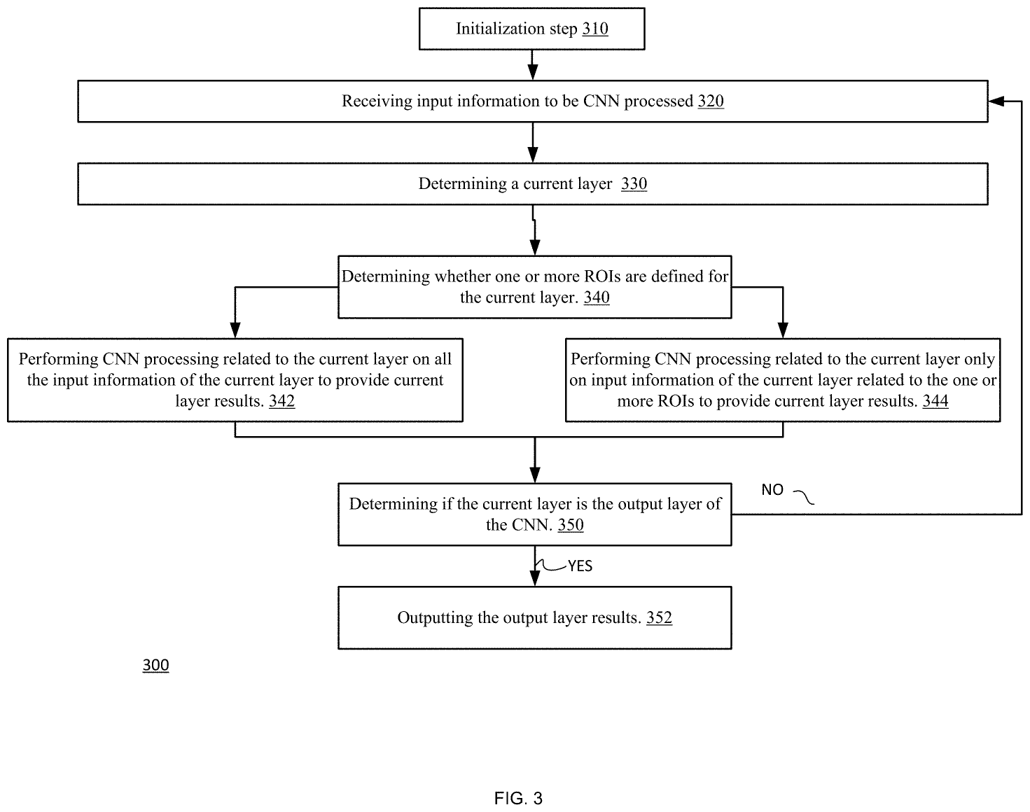

FIG. 3 illustrates method 300 for CNN processing.

Method 300 starts by step 310 of initialization. Step 310 may include receiving definitions of one of more ROIs of one or more layers of a CNN. The one or more layers may include any layer of the CNN. There may be one or more ROIs per a single layer.

Step 310 may be followed by step 320 of receiving input information to be CNN processed.

Step 320 may be followed by step 330 of determining a current layer. At a first iteration of step 330 the current layer is the input layer. At iterations other then the first iteration the current layer is the layer that follows the current layer of the previous iteration of step 330.

Step 330 may be followed by step 340 of determining whether one or more ROIs are defined for the current layer.

If no ROIs are defined for the current layer then step 340 is followed by step 342 of performing CNN processing related to the current layer on all the input information of the current layer to provide current layer results.

If one or more ROIs are defined for the current layer then step 340 is followed by step 344 of performing CNN processing related to the current layer only on input information of the current layer related to the one or more ROIs to provide current layer results. Input information related to the current layer but outside any of the one or more ROIs are not processed during step 344.

Step 344 may include selectively feeding to a convolutional unit the information that should be processed.

Steps 342 and 344 are followed by step 350 of determining if the current layer is the output layer of the CNN.

If the current layer is the output layer then step 350 is followed by step 352 of outputting the output layer results.

If the current layer is not the output layer then step 350 is followed by step 330. In this case step 330 select the next layer to be the new current layer.

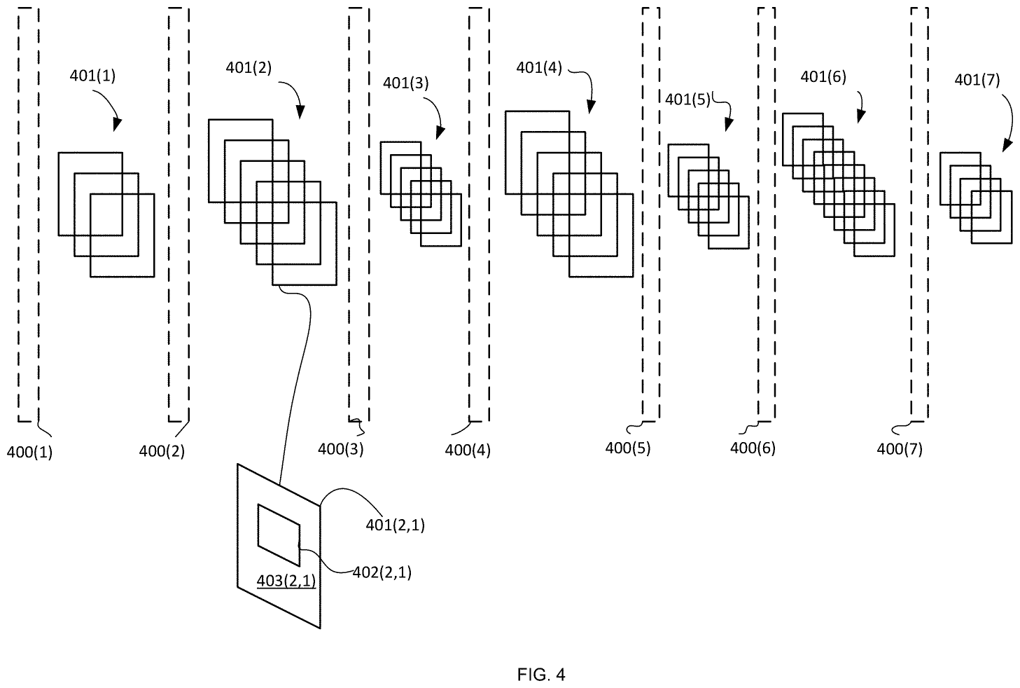

FIG. 4 illustrates an example of a CNN 400 and various information units.

CNN 400 includes input layer 400(1), one or more intermediate layers such as 400(2)-400(6) and output layer 400(7).

Input layer 400(1) received input information 401(1) such as an RGB image that may be represented by three monochromatic images channels—a red image, a blue image and a green image.

A first intermediate layer 400(2) may generate first intermediate results by (a) processing the entire received input information 401(1)—if there is no ROI defined in the first intermediate layer, or (b) if there is one or more ROI defined in the first intermediate layer 400(2)—processing only input information 401(1) related to any of that one or more ROI.

Assuming, for example, that the second intermediate layer 400(3) defined an ROI—then second intermediate layer 400(3) may generate second intermediate results 401(3) by processing only first intermediate results 401(1) related to the ROI (see 402(2,1)) while ignoring first intermediate results 401(1) not related to the ROI (see 403(2,1)). Channel information 401(1,2) is a part of the first intermediate results 401(1), and the same ROI may be defined in all other channel information that belongs to the first intermediate results 401(1).

The same process is applied by the third till fifth intermediate layers 400(3)-400(6) to provide third till fifth intermediate results 401(3)-401(6), and then processing the fifth intermediate results by the output layer 400(7) to provide output layer results 401(7).

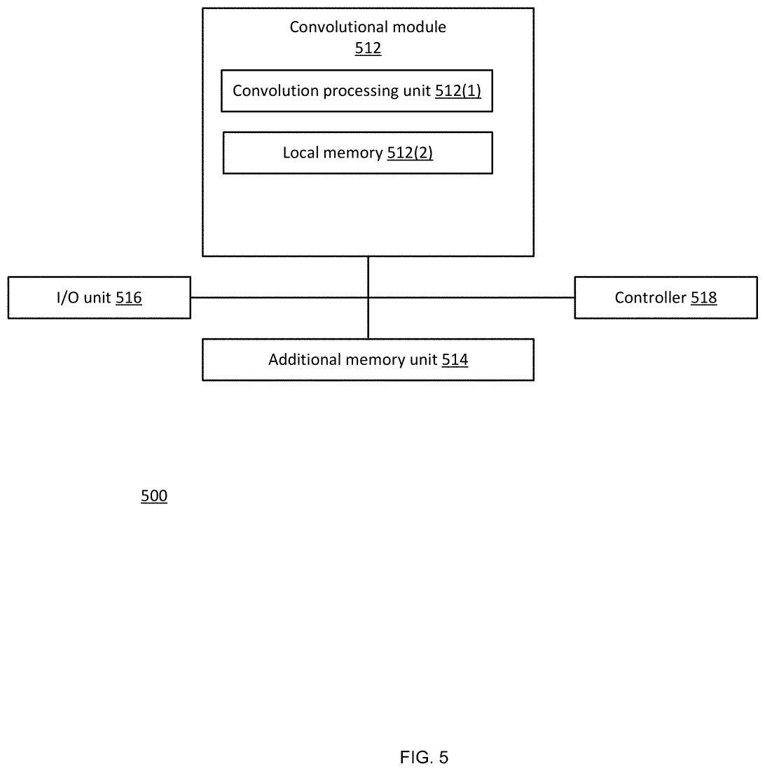

FIG. 5 illustrates an example of a neural network processor 500.

The neural network processor 500 may be an CNN processor, may be an integrated circuit, may be included in an integrated circuits, may include one or more processing circuits, and the like.

Neural network processor 500 may include controller 518 and convolutional module 512. The convolutional module 512 may include a convolution processing unit 512(1) that may calculate convolutions and a local memory 512(2) that may feed information and/or coefficients to the convolution processing unit 512(1).

FIG. 5 also illustrates an input output unit (I/O unit 516) and additional memory unit 514 that may feed information and/or coefficients to the convolutional module 512. The additional memory unit 514 may exceed the local memory 512(2).

The I/O unit 516 may be configured to receive information, coefficients, definitions of one or more ROIs, and may output information and/or output results.

The controller 518 may control the provision of information and/or coefficients from the additional memory 514 and/or the local memory 512(2) to the convolution processing unit 512(1) based on the existence or lack of existence of region of interest in a layer (for example an intermediate layer) of a CNN network implemented by the neural network processor 500. For example—information and/or coefficients related to areas outside one or more ROI of an intermediate layer are not fed to the convolution processing unit 512(1) and/or to the convolutional module 512.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

In the foregoing specification, the invention has been described with reference to specific examples of embodiments of the invention. It will, however, be evident that various modifications and changes may be made therein without departing from the broader spirit and scope of the invention as set forth in the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the invention described herein are, for example, capable of operation in other orientations than those illustrated or otherwise described herein.

Furthermore, the terms “assert” or “set” and “negate” (or “deassert” or “clear”) are used herein when referring to the rendering of a signal, status bit, or similar apparatus into its logically true or logically false state, respectively. If the logically true state is a logic level one, the logically false state is a logic level zero. And if the logically true state is a logic level zero, the logically false state is a logic level one.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

1. A method for region of interest (ROI) convolutional neural network (CNN) processing, the method comprises:
applying, by the CNN, multiple CNN processing operations on input information received by the CNN, to provide one or more CNN output results;
wherein the applying comprises:
receiving, by a first intermediate CNN layer of the CNN, first intermediate information from a layer that precedes the first intermediate CNN layer;
applying, by the first intermediate CNN layer, a CNN processing operation only on first intermediate information included within a first ROI; and
preventing from applying the CNN processing operation on intermediate information outside the first ROI.

2. The method according to claim 1 comprising receiving a definition of the first ROI.

3. The method according to claim 1 wherein the applying comprises:
receiving, by a second intermediate CNN layer of the CNN, second intermediate information from a layer that precedes the second intermediate CNN layer; wherein the second intermediate CNN layer differs from the first intermediate CNN layer;
applying, by the second intermediate CNN layer, a CNN processing operation only on second intermediate information included within a second region of interest (ROI); and
preventing from applying the CNN processing operation on intermediate information outside the second ROI.

4. The method according to claim 1 wherein the applying comprises generating the first intermediate information by one or more layers of the CNN that precede the first intermediate CNN layer.

5. The method according to claim 1 wherein the applying comprises implementing CNN processing by different intermediate layers by reusing a convolutional module.

6. The method according to claim 5 wherein the reusing comprises dynamically adjusting regions of interest between one use of the convolutional module to another.

7. A non-transitory computer readable medium for region of interest (ROI) convolutional neural network (CNN) processing, the non-transitory computer readable medium stores instructions for:
applying, by the CNN, multiple CNN processing operations on input information received by the CNN, to provide one or more CNN output results;
wherein the applying comprises:
receiving, by a first intermediate CNN layer of the CNN, first intermediate information from a layer that precedes the first intermediate CNN layer;
applying, by the first intermediate CNN layer, a CNN processing operation only on first intermediate information included within a first ROI; and
preventing from applying the CNN processing operation on intermediate information outside the first ROI.

8. The non-transitory computer readable medium according to claim 7 comprising receiving a definition of the first ROI.

9. The non-transitory computer readable medium according to claim 7 wherein the applying comprises:
receiving, by a second intermediate CNN layer of the CNN, second intermediate information from a layer that precedes the second intermediate CNN layer; wherein the second intermediate CNN layer differs from the first intermediate CNN layer;
applying, by the second intermediate CNN layer, a CNN processing operation only on second intermediate information included within a second region of interest (ROI); and
preventing from applying the CNN processing operation on intermediate information outside the second ROI.

10. The non-transitory computer readable medium according to claim 7 wherein the applying comprises generating the first intermediate information by one or more layers of the CNN that precede the first intermediate CNN layer.

11. The non-transitory computer readable medium according to claim 7 wherein the applying comprises implementing CNN processing by different intermediate layers by reusing a convolutional module.

12. The non-transitory computer readable medium according to claim 11 wherein the reusing comprises dynamically adjusting regions of interest between one use of the convolutional module to another.

13. A neural network processor for region of interest (ROI) convolutional neural network (CNN) processing, the neural network processor either comprises a CNN or is configured to implement a CNN;
wherein the neural network processor is configured to apply multiple CNN processing operations on input information received by the neural network processor, to provide one or more CNN output results;
wherein the applying comprises:
receiving, by a first intermediate CNN layer of the CNN, first intermediate information from a layer that precedes the first intermediate CNN layer;
applying, by the first intermediate CNN layer, a CNN processing operation only on first intermediate information included within a first ROI; and
preventing from applying the CNN processing operation on intermediate information outside the first ROI.

14. The neural network processor according to claim 13 that is configured to receive a definition of the first ROI.

15. The neural network processor according to claim 14 that is configured to:
receive, by a second intermediate CNN layer of the CNN, second intermediate information from a layer that precedes the second intermediate CNN layer; wherein the second intermediate CNN layer differs from the first intermediate CNN layer;
apply, by the second intermediate CNN layer, a CNN processing operation only on second intermediate information included within a second region of interest (ROI); and
prevent from applying the CNN processing operation on intermediate information outside the second ROI.

16. The neural network processor according to claim 13 that is configured to generate the first intermediate information by one or more layers of the CNN that precede the first intermediate CNN layer.

17. The neural network processor according to claim 7 that is configured to implement CNN processing by different intermediate layers by reusing a convolutional module.

18. The neural network processor according to claim 17 wherein the reusing comprises dynamically adjusting regions of interest between one use of the convolutional module to another.
